(19) United States
(12) Patent Application Publication
(10) Pub. No.: US 2021/0157879 A1
(43) Pub. Date: May 27, 2021

(54) DATA ANALYSIS DEVICE, METHOD, AND PROGRAM

(71) Applicant: NIPPON TELEGRAPH AND TELEPHONE CORPORATION, Tokyo (JP)

(72) Inventors: Masahiro KOJIMA, Tokyo (JP); Tatsushi MATSUBAYASHI, Tokyo (JP); Hiroyuki TODA, Tokyo (JP)

(73) Assignee: NIPPON TELEGRAPH AND TELEPHONE CORPORATION, Tokyo (JP)

(21) Appl. No.: 17/259,133

(22) PCT Filed: Jul. 10, 2019
(86) PCT No.: PCT/JP2019/027368

§ 371 Date: Jan. 8, 2021

(30) Foreign Application Priority Data
Jul. 11, 2018 (JP) 2018-131626

(51) Int. Cl. G06F 17/16; G06F 17/18

(52) U.S. Cl. CPC G06F 17/16; G06F 17/18

(57) ABSTRACT

An interval-valued matrix including elements represented by interval values can be resolved into factor matrices with high accuracy. A parameter estimation unit 20 estimates a factor matrix A and a factor matrix B such that an objective function, represented by including a probability of an element xᵢⱼ taking a scalar value thereof, which is represented using an estimate of the element xᵢⱼ estimated from the factor matrix A and the factor matrix B, for each element xᵢⱼ that is a scalar value, and a probability of the element xᵢⱼ taking an interval value thereof, which is represented using the estimate of the element xᵢⱼ estimated from the factor matrix A and the factor matrix B, for each element xᵢⱼ that is an interval value, is optimized.

### TECHNICAL FIELD

The present invention relates to a data analysis device, method, and program.

### BACKGROUND ART

In recent years, a method called nonnegative matrix factorization (NMF) has been widely used in data analysis (refer to NPL 2 and 3). A lot of data of analysis objects such as text and a purchase history can be represented as a matrix, and thus it is possible to automatically extract a pattern in data or supplement a missing value in the data by factorizing the data represented as a matrix according to NMF into a product of nonnegative matrices. However, there are cases in which various types of collected data are combined and analyzed, and then data in which only ranges including values have been observed as well as data in which specific values have been observed need to be combined and analyzed in recent data analysis. For example, it is conceivable that a retail shop combines and analyzes data of member users and nonmember users collected through questionnaires in order to understand customers. In this case, for example, it is possible to ascertain a specific value such as 2.43 times per week as an average number of visits of a member user from data accumulated in a membership card or the like, but in the case of a nonmember user collected through a questionnaire, only information of a range of values, such as three times to seven times per week from a questionnaire reply, can be ascertained (FIG. 1). Such data is represented as an interval-valued matrix in which elements are represented as scalar values or interval values, as shown in the figure.

### CITATION LIST

### Non Patent Literature

[NPL 1] Z. Shen, L. Du, X. Shen, and Y. Shen, Interval-valued matrix factorization with applications, In ICDM, pp. 1037-1042, IEEE, 2010
[NPL 2] Masahiro Kohjima, Tatsushi Matsubayashi, Hiroshi Sawada, “Multiple Data Analysis and Non-negative Matrix/Tensor Factorization [1]: Multiple Data Analysis and Its Advances,” The Journal of the Institute of Electronics, Information and Communication Engineers, Vol. 99, No. 6, pp. 543-550, June 2016.
[NPL 3] Hiroshi Sawada, “Nonnegative Matrix Factorization and Its Applications to Data/Signal Analysis,” The journal of the Institute of Electronics, Information and Communication Engineers, Vol. 95, No. 9, pp. 829-833, September 2012

### SUMMARY OF THE INVENTION

### Technical Problem

However, NMF cannot be applied to a matrix in which elements are represented as interval values. In addition, there is a method according to Shen et al. in which a matrix represented as interval values is used as an input as a method most relevant to a method of the present invention (NPL 1). In this method, a lower limit x^{L}ᵢⱼ of interval-valued elements is extracted from an interval-valued matrix to form

X^{low}

and an upper limit x^{R}ᵢⱼ is extracted as

X^{up}

so that two matrices

X^{low}

and

Xᵤₚ

are generated,

and factorization is performed such as

X^{low}≈\hat{X}^{low}=UV^{low},X^{high}≈\hat{X}^{up}=UV^{high}.

In addition, a scalar missing value of an input matrix is supplemented by an element value corresponding to

(\hat{X}^{low}+\hat{X}^{up})/2.

In this approach, there are problems in pattern extraction and missing supplementation. In pattern extraction,

V^{low} and V^{up}

are output in a column direction, and thus it cannot be ascertained which matrix needs to be viewed to take a pattern of objects corresponding to a column. Further, since a missing value is supplemented as a simple average of

\hat{X}^{low} and \hat{X}^{up}

it is biased to an interval-valued element, and thus it can be predicted that there will be deterioration in estimation accuracy, for example, when an upper limit of interval values is set to a value equal to or more than necessary.

An object of the present invention devised in view of the aforementioned circumstances is to provide a data analysis device, method and program which can resolve an interval-valued matrix including elements represented as interval values into factor matrices with high accuracy.

### Means for Solving the Problem

To accomplish the aforementioned object, a data analysis device according to the first invention is a data analysis device for resolving an interval-valued matrix X that is an I×J matrix having an element xᵢⱼ representing a relationship between a first object i (1≤i≤I, I is an integer equal to or greater than 1) and a second object j (1≤j≤J, J is an integer equal to or greater than 1), the element xᵢⱼ being a scalar value or an interval value, into an I×R factor matrix A having an element aᵢᵣ representing a relationship between the first object i and a factor r (1≤r≤R, R is an integer equal to or greater than 1) and a J×R factor matrix B having an element bⱼᵣ representing a relationship between the second object j and the factor r, the data analysis device including a parameter estimation unit which estimates the factor matrix A and the factor matrix B such that an objective function, represented by including a probability of the element xᵢⱼ taking a scalar value thereof, which is represented using an estimate of the element xᵢⱼ estimated from the factor matrix A and the factor matrix B, for each element xᵢⱼ that is a scalar value, and a probability of the element xᵢⱼ taking an interval value thereof, which is represented using the estimate of the element xᵢⱼ estimated from the factor matrix A and the factor matrix B, for each element xᵢⱼ that is an interval value, is optimized.

A data analysis method according to the second invention is a data analysis method in a data analysis device for resolving an interval-valued matrix X that is an I×J matrix having an element xᵢⱼ representing a relationship between a first object i (1≤i≤I, I is an integer equal to or greater than 1) and a second object j (1≤j≤J, J is an integer equal to or greater than 1), the element xᵢⱼ being a scalar value or an interval value, into an I×R factor matrix A having an element aᵢᵣ representing a relationship between the first object i and a factor r (1≤r≤R, R is an integer equal to or greater than 1) and a J×R factor matrix B having an element bⱼᵣ representing a relationship between the second object j and the factor r, the data analysis method including estimating, by a parameter estimation unit, the factor matrix A and the factor matrix B such that an objective function, represented by including a probability of the element xᵢⱼ taking a scalar value thereof, which is represented using an estimate of the element xᵢⱼ estimated from the factor matrix A and the factor matrix B, for each element xᵢⱼ that is a scalar value, and a probability of the element xᵢⱼ taking an interval value thereof, which is represented using the estimate of the element xᵢⱼ) estimated from the factor matrix A and the factor matrix B, for each element xᵢⱼ that is an interval value, is optimized.

A program according to the third invention is a program for causing a computer to serve as each component constituting the aforementioned data analysis device.

### Effects of the Invention

As described above, according to the data analysis device, method and program of the present invention, it is possible to resolve an interval-valued matrix including elements represented by interval values into factor matrices with high accuracy by estimating the factor matrix A and the factor matrix B such that an objective function, represented by including a probability of the element xᵢⱼ taking a scalar value thereof, which is represented using an estimate of the element xᵢⱼ estimated from the factor matrix A and the factor matrix B, for each element xᵢⱼ that is a scalar value, and a probability of the element xᵢⱼ taking an interval value thereof, which is represented using the estimate of the element xᵢⱼ estimated from the factor matrix A and the factor matrix B, for each element xᵢⱼ that is an interval value, is optimized.

### BRIEF DESCRIPTION OF DRAWINGS

FIG. 1 is a diagram showing an example of an interval-valued matrix.

FIG. 2 is a flowchart of an overview operation of a data analysis device in an embodiment of the present invention.

FIG. 3 shows a configuration example of the data analysis device in an embodiment of the present invention.

FIG. 4 is a flowchart when parameter estimation is performed in an embodiment of the present invention.

### DESCRIPTION OF EMBODIMENTS

Hereinafter, an embodiment of the present invention will be described in detail with reference to the drawings.

<Overview of Embodiment of the Present Invention>

In an embodiment of the present invention, a method of factorizing an interval-valued matrix in which elements are represented as scalar values or interval values is presented. Accordingly, it is possible to extract a latent pattern or supplement a missing value with high accuracy from data represented as a matrix having scalar values and interval values, such as a set of data of a member user and data of a nonmember user collected through questionnaires.

In addition, in the embodiment of the present invention, a method of setting one factor matrix used in a row direction and a column direction (a total of two factor matrices) even in the case of a matrix in which elements are represented as interval values is constructed. Further, it is possible to allow a missing value to be estimated with high accuracy even when interval-valued elements are biased by conceiving representation of a data generation process according to a probability distribution.

<Formulation>

It is assumed that data is represented as an interval-valued matrix X having I rows and J columns. The interval-valued matrix X is composed of scalar-valued elements xᵢⱼ and interval-valued elements x^{L}ᵢⱼ and x^{R}ᵢⱼ and represented as

X={xᵢⱼ}_{(i,j)∈Ω}_{^{sv}}∪{(xᵢⱼ^{L},xᵢⱼ^{R})}_{(i,j)∈Ω}_{^{iv}}.

However, Ω^{sv} and Ω^{iv} respectively represent all elements having scalar values and all elements having interval values. In addition, all elements (a union of the aforementioned sets) having values observed are denoted as Ω=Ω^{sv} U Ω^{iv}. The interval-valued elements (x^{L}ᵢⱼ, X^{R}ᵢⱼ) represent that scalar values xᵢⱼ in the elements are within a range of intervals as follows although the scalar values xᵢⱼ are not ascertained.

xᵢⱼ^{L}≤xᵢⱼ≤xᵢⱼ^{R}.

A parameter estimated through a method of the embodiment of the present invention is denoted by θ. θ is composed of factor matrices of

A={aᵢᵣ}_{i,r=1}^{I,R},B={bⱼᵣ}_{j,r=1}^{J,R}

and an accuracy τ. The factor matrix A is an I×R matrix having an element aᵢᵣ that represents a relationship between a first object i and a factor r (1≤r≤R, R is an integer equal to or greater than 1). The factor matrix B is a J×R matrix having an element bⱼᵣ that represents a relationship between a second object j and the factor r. R represents the number of factors of a factor matrix. A model in which the elements of the interval-valued matrix X are assumed to conform to a normal distribution is conceivable according to formulation of normal NMF.

[Formula 1]

P(xᵢⱼ|Θ={A,B,τ})=∫(xᵢⱼ|\dot{x}ᵢⱼ,τ), (1)

However,

\hat{x}ᵢⱼ=Σᵣ₌₁^{R}aᵢᵣbⱼᵣ

is defined, and f represents a probability density function of the following normal distribution.

$$\begin{matrix}[ Formula 2 ] & \\ f ( x \vert μ , r ) = \frac{1}{\sqrt{2 π {τ}^{- 1}}} exp \{ - \frac{T}{2} {( x - μ )}^{2} \} . & ( 2 )\end{matrix}$$

Meanwhile, the present invention is also established in the same manner when models assumed to conform to other probability distributions such as the Poisson distribution are conceived. After interval-valued elements are handled, it is important to use a cumulative density function (CDF) F.

[Formula 3]

F(C|μ,τ)=∫_{-∞}^{C}f(x|μ,τ)dx (3)

CDF is defined as above, and F(C|μ, τ) represents that a random variable conforming to a probability distribution in which a probability density function is f has a value equal to or less than C. Accordingly, a probability of the value xᵢⱼ having a value in the interval between x^{L}ᵢⱼ and X^{R}ᵢⱼ can be represented by

[Formula 4]

P(xᵢⱼ∈(xᵢⱼ^{L},xᵢⱼ^{R})|Θ)=F(xᵢⱼ^{R}|\hat{x}ᵢⱼ,τ)−F(xᵢⱼ^{L}|\hat{x}ᵢⱼ,τ). (4).

This fact shows that a probability of generation of the interval-valued matrix X when a certain parameter θ is given can be written as represented by the following formula.

$$\begin{matrix}[ Formula 5 ] & \\ P ( X \vert Θ ) = {\prod }_{( i , j ) ∈ {Ω}^{sv}} P ( {x}_{ij} \vert Θ ) {\prod }_{( i , j ) ∈ {Ω}^{iv}} P ( {x}_{ij} ∈ ( {x}_{ij}^{L} , {x}_{ij}^{R} ) \vert Θ . & ( 5 )\end{matrix}$$

Accordingly, it can be ascertained that it is desirable to estimate the parameter θ by optimizing the following log-likelihood function.

$$\begin{matrix}[ Formula 6 ] & \\ {arg min }_{Θ} ℒ ( Θ ) = - log P ( X \vert Θ ) , s . t . A \geq 0 , B \geq 0 , τ \geq 0 & ( 6 )\end{matrix}$$

However,

A≥0

represents that all elements of the factor matrix A are nonnegative. Extracting a pattern that can be analyzed by imposing nonnegative constraint to A and B is empirically known (refer to NPL3).

In the embodiment of the present invention, the factor matrix A and the factor matrix B are estimated such that an objective function as follows is optimized, as represented in the above formula (6). The objective function as follows is represented by including a probability of elements xᵢⱼ taking scalar values thereof for each element xᵢⱼ that is a scalar value and a probability of elements xᵢⱼ taking interval values thereof for each element xᵢⱼ that is an interval value. Here, a probability of each element xᵢⱼ that is a scalar value thereof taking a scalar value is represented using an estimate of the element xᵢⱼ estimated from the factor matrix A and the factor matrix B. In addition, a probability of each element xᵢⱼ that is an interval value thereof taking an interval value is represented using an estimate of the element xᵢⱼ estimated from the factor matrix A and the factor matrix B. Here, a probability of an element x₁ taking a scalar value thereof is represented by a probability density function of a normal distribution, as represented by the above formula (2). In addition, a probability of an element xᵢⱼ taking an interval value thereof is represented by a difference between a cumulative density function that represents a probability of the element xᵢⱼ taking a value equal to or less than an upper limit value of the interval value thereof and a cumulative density function that represents a probability of the element xᵢⱼ taking a value equal to or less than a lower limit value of the interval value thereof, as represented by the above formula (4).

Meanwhile, when pattern analysis is not required, such as a case in which only supplementation of a missing value needs to be performed, there are cases in which factorization is performed free from the nonnegative constraint of factor matrices. The present invention is also applicable to such cases. Specifically, the following optimization problem may be conceived.

$$\begin{matrix}[ Formula 7 ] & \\ {arg min }_{Θ} ℒ ( Θ ) = - log P ( X \vert Θ ) , s . t . τ \geq 0. & ( 7 )\end{matrix}$$

<Estimation Algorithm According to Auxiliary Function Method>

Any optimization method can be used to estimate the parameter θ. In the present embodiment, a case in which an estimation algorithm according to an auxiliary function method (refer to NPL3) is used as an example of a parameter estimation method that is a solution to the optimization problem of formula (6) is exemplified. In the auxiliary function method, an auxiliary function L⁺ that is an upper bound of an objective function L is used. An auxiliary function in a model of the embodiment of the present invention is given as follows.

$$\begin{matrix} [ Formula 8 ] & \\ {ℒ}^{+} ( q , S , Θ ) = {𝔼}_{q} [ - log h ( X , Y , Θ , S ) ] + \int q ( Y ) log q ( Y ) dY & ( 8 ) \\ [ Formula 9 ] & \\ log h ( X , Y , Θ , S ) = - \frac{N}{2} log ( 2 {πτ}^{- 1} ) - {\sum }_{( i , j ) ∈ {Ω}^{sv}} \frac{τ}{2} \{ {x}_{ij}^{2} - 2 {x}_{ij} {\hat{x}}_{ij} + {\sum }_{r = 1}^{R} \frac{{( {a}_{ir} {b}_{jr} )}^{2}}{{s}_{ijr}} \} - {\sum }_{( i , j ) ∈ {Ω}^{iv}} \frac{τ}{2} \{ {y}_{ij}^{2} - 2 {y}_{ij} {\hat{x}}_{ij} + {\sum }_{r = 1}^{R} \frac{{( {a}_{ir} {b}_{jr} )}^{2}}{{s}_{ijr}} \} & ( 9 )\end{matrix}$$

However,

Y={yᵢⱼ}_{(i,j)∈Ω}_{^{iv}}

is a latent variable, the element yᵢⱼ∈(x^{L}ᵢⱼ; x^{R}ᵢⱼ) of which represents a scalar value in elements assigned interval values. In addition, q(Y) represents an auxiliary function in which an auxiliary distribution S={sᵢⱼᵣ} to which Y conforms satisfies

Σᵣsᵢⱼᵣ=1(∇(i,j))

This auxiliary function L⁺ has two properties as follows.

1. [symbol] (Θ)≤ [symbol] ⁺(q,S,Θ). 2. [symbol] (Θ)=min_{q,S} [symbol] ⁺(q,S,Θ).

Equality sign establishment conditions are as follows.

$$\begin{matrix}[ Formula 10 ] & \\ q ( {y}_{ij} ) = {f}_{tr} ( {y}_{ij} \vert {\hat{x}}_{ij} , τ , {x}_{ij}^{L} , {x}_{ij}^{R} ) , {s}_{ijr} = \frac{{a}_{ir} {b}_{jr}}{{\sum }_{{r}^{′}} {a}_{{ir}^{′}} {b}_{{jr}^{′}}} . & ( 10 )\end{matrix}$$

fₜᵣ(x|μ, τ, a, b) represents a truncated normal distribution. A probability density function of the truncated normal distribution is given as the following formula:

$${f}_{tr} ( x \vert μ , τ , a , b ) = \{ \begin{matrix}\frac{f ( x \vert μ , τ )}{F ( b \vert μ , τ ) - F ( a \vert μ , τ )} & ( if x ∈ ( a , b ) ) \\ 0 & ( otherwise )\end{matrix}$$

An algorithm is derived by conceiving optimization for each parameter of the auxiliary function as follows.

Minimize [symbol] ⁺(q,S,Θ) w.r.t. A or B. (1)

Minimize [symbol] ⁺(q,S,Θ) w.r.t. A and q. (2)

Minimize [symbol] ⁺(q,S,Θ) w.r.t. τ. (3)

The derived algorithm is as follows.

$$\begin{matrix}[ Formula 11 ] & \\ {a}_{ir} ← {a}_{ir} \frac{{\sum }_{j ∈ {Ω}_{i}^{sv}} {x}_{ij} {b}_{jr} + {\sum }_{j ∈ {Ω}_{i}^{iv}} {\overline{y}}_{ij} {b}_{jr}}{{\sum }_{j ∈ {Ω}_{i}} {\hat{x}}_{ij} {b}_{jr}} , & ( 11 ) \\ [ Formula 12 ] & \\ {b}_{jr} ← {b}_{jr} \frac{{\sum }_{j ∈ {Ω}_{j}^{sv}} {x}_{ij} {a}_{jr} + {\sum }_{j ∈ {Ω}_{j}^{iv}} {\overline{y}}_{ij} {a}_{ir}}{{\sum }_{j ∈ {Ω}_{i}} {\hat{x}}_{ij} {a}_{ir}} & ( 12 ) \\ [ Formula 13 ] & \\ {\overline{y}}_{jr} ← {𝔼}_{q ( Y )} [ {y}_{ij} ] , & \text{(13)} \\ [ Formula 14 ] & \\ {\overline{y}}_{ij}^{( 2 )} ← {𝔼}_{q ( Y )} [ {y}_{ij}^{2} ] , & ( 14 ) \\ [ Formula 15 ] & \\ {r}^{- 1} ← \frac{1}{N} \{ {\sum }_{( i , j ) ∈ {Ω}^{sv}} {( {x}_{ij} - {\hat{x}}_{ij} )}^{2} + {\sum }_{( i , j ) ∈ {Ω}^{iv}} ( {\overline{y}}_{ij}^{( 2 )} - 2 {\overline{y}}_{ij} {\hat{x}}_{ij} + {x}_{ij}^{2} ) \} . & ( 15 ) \\ {𝔼}_{q ( Y )} & \end{matrix}$$

represents an average with respect to output of the random variable Y conforming to the probability distribution q(Y).

[symbol]

_{q(Y)}[yᵢⱼ] [symbol] _{q(Y)}[yᵢⱼ²]

and
correspond to primary and secondary moments of the probability distribution q(Y). Since q(Y) is a truncated normal distribution when the probability density function f is a normal distribution, the moments are values that can be analytically calculated. Even when a distribution in which the moments of q(Y) cannot be analytically calculated is used as the probability density function f, the moments of q(Y) can be calculated using an expected value calculation method using random numbers, such as importance sampling and a rejection method. When the right side of an update formula of the factor matrix A is focused upon, it is ascertained that (I) the right side is equal to or greater than 0 all the time and (II) the right side is consistent with the left side and update stops when

xᵢⱼ=\hat{x}ᵢⱼ=y̅ᵢⱼ.

The parameter is updated according to the formulas (11) to (15), and thus the objective function can reach a (local) optimum solution.

First, an overview operation of the present invention will be described.

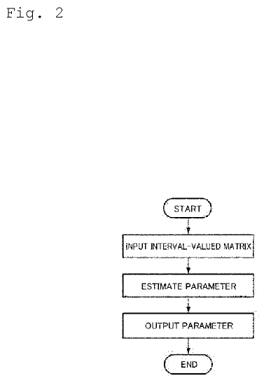

FIG. 2 is a flowchart of an overview operation of a data analysis device in an embodiment of the present invention.

Step 1) An interval-valued matrix X is input.

Step 2) A parameter θ is estimated.

Step 3) The parameter θ is output.

<Configuration of Data Analysis Device 1>

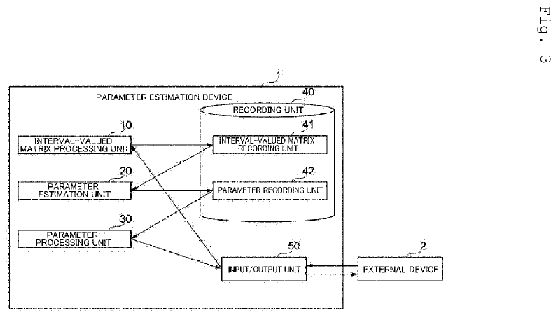

As shown in FIG. 3, a data analysis device 1 according to an embodiment of the present invention is configured as a computer including a central processing unit (CPU), a random access memory (RAM), and a read only memory (ROM) storing a program for executing a data analysis processing routine which will be described later and functionally configured as follows. The data analysis device 1 includes an interval-valued matrix processing unit 10, a parameter estimation unit 20, a parameter processing unit 30, a recording unit 40, and an input/output unit 50.

The input/output unit 50 receives an interval-valued matrix X output from an external device 2. In addition, the input/output unit 50 outputs a result of estimation of a parameter θ performed by the parameter estimation unit 20 to the external device 2.

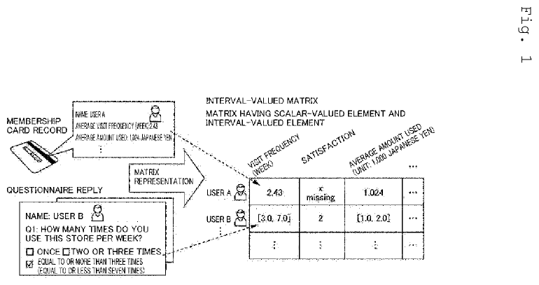

The interval-valued matrix X is an I×J matrix having an element xᵢⱼ representing a relationship between a first object i (1≤i≤I, I is an integer equal to or greater than 1) and a second object j (1≤j≤J, J is an integer equal to or greater than 1). In addition, the interval-valued matrix X is a matrix in which an element xᵢⱼ is a scalar value or an interval value. For example, the first object i is a user, the second object j is items (visit frequency, satisfaction, and average amount used) of a questionnaire with respect to use of a retail shop, and the element xᵢⱼ represents a reply (scalar value or interval value) to a j-th questionnaire item according to an i-th user (refer to FIG. 1).

The recording unit 40 includes an interval-valued matrix recording unit 41 and a parameter recording unit 42.

The interval-valued matrix recording unit 41 records the input interval-valued matrix X.

The parameter recording unit 42 records the result of estimation of the parameter θ performed by the parameter estimation unit 20.

The interval-valued matrix processing unit 10 stores the input interval-valued matrix X in the interval-valued matrix recording unit 41.

The parameter estimation unit 20 repeats acquisition of the parameter θ including a factor matrix A, a factor matrix B, and an accuracy τ until predetermined repetition end conditions are satisfied. Here, in acquisition of the parameter θ, the parameter estimation unit 20 uses the interval-valued matrix X of the interval-valued matrix recording unit 41 as an input and obtains the parameter θ such that an auxiliary function (formula (8)) that is an upper-bound function of the objective function of formula (6) is minimized according to a method which will be described below. Thereafter, the parameter estimation unit 20 stores the parameter θ in the parameter recording unit 42.

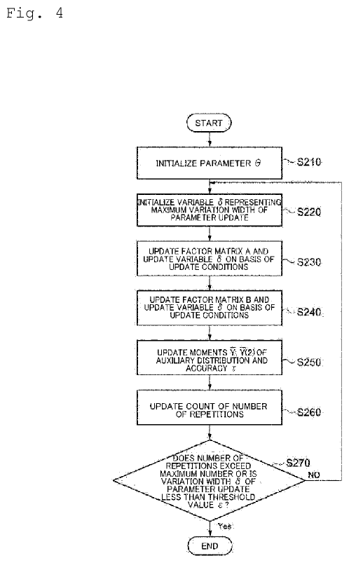

FIG. 4 shows an updated flowchart when parameter estimation is performed by the parameter estimation unit 20.

First, the parameter estimation unit 20 initializes the parameter θ stored in the parameter recording unit 42 in step S210.

In step S220, the parameter estimation unit 20 initializes a variable S that represents a maximum variation width of an update amount as a variable used in the repetition end conditions like the parameter 9, and sets a threshold value E and a maximum number of repetitions of the repetition end conditions.

In step S230, the parameter estimation unit 20 updates the factor matrix A according to the formula (11) on the basis of the interval-valued matrix X, the factor matrix A, the factor matrix B, and moments of an auxiliary distribution,

Y̅,Y̅⁽²⁾.

Here, if a maximum value of the absolute value of a difference between the factor matrix A before update and the factor matrix A after update,

max_{i,r}|aᵢᵣ^{old}−aᵢᵣ^{new}|,

is greater than δ, the parameter estimation unit 20 updates

δ←max_{i,r}|aᵢᵣ^{old}−aᵢᵣ^{new}|.

Meanwhile, the symbol “←” means a process of substituting the calculation result of the right side into the variable of the left side. Further, an element of the factor matrix A before update is represented as a^{old}ᵢᵣ and an element of the factor matrix A after update is represented as a^{new}ᵢᵣ.

In step S240, the parameter estimation unit 20 updates the factor matrix B according to the formula (12) on the basis of the interval-valued matrix X, the factor matrix A, the factor matrix B, and the moments of the supplementary distribution,

Y̅,Y̅⁽²⁾.

Here, if a maximum value of the absolute value of a difference between the factor matrix B before update and the factor matrix B after update,

max_{j,r}|bⱼᵣ^{old}−bⱼᵣ^{new}|,

is greater than δ, the parameter estimation unit 20 updates

δ←max_{j,r}|bⱼᵣ^{old}−aⱼᵣ^{new}|.

Here, an element of the factor matrix B before update is represented as b^{old}ᵢᵣ and an element of the factor matrix B after update is represented as b^{new}ᵢᵣ.

In step S250, the parameter estimation unit 20 updates the moments of the auxiliary distribution,

Y̅,Y̅⁽²⁾

and the accuracy i according to formulas (13) to (15) on the basis of the interval-valued matrix X, the factor matrix A, the factor matrix B, and the moments of the auxiliary distribution,

Y̅,Y̅⁽²⁾.

In step S260, the parameter estimation unit 20 updates the number of calculation repetitions.

In step S270, the parameter estimation unit 20 determines whether the repetition end conditions are satisfied. In the present embodiment, if the number of calculation repetitions exceeds a predetermined maximum number of repetitions or S that represents a maximum variation width according to parameter update is less than the predetermined threshold value s, the parameter estimation unit 20 determines that the repetition end conditions are satisfied and ends the processing routine. If not, the parameter estimation unit 20 returns to step S220, performs initialization such as &-0 and then proceeds to step S230.

<Parameter Processing Unit 30>

The parameter processing unit 30 outputs the parameter θ with reference to the parameter recording unit 42 as will be described below.

As described above, the data analysis device according to an embodiment of the present invention can resolve an interval-valued matrix including elements represented by interval values into factor matrices with high accuracy by estimating the factor matrix A and the factor matrix B such that an objective function as follows is optimized. The aforementioned objective function as follows is represented by including a probability of elements xᵢⱼ taking scalar values thereof for each element xᵢⱼ that is a scalar value and a probability of elements xᵢⱼ taking interval values thereof for each element xᵢⱼ that is an interval value. Here, a probability of each element xᵢⱼ that is a scalar value taking a scalar value thereof is represented using an estimate of the element xᵢⱼ estimated from the factor matrix A and the factor matrix B. In addition, a probability of each element xᵢⱼ that is an interval value taking an interval value thereof is represented using an estimate of the element xᵢⱼ estimated from the factor matrix A and the factor matrix B.

In addition, a parameter of a model including a factor matrix can be estimated from data represented as an interval-valued matrix. Accordingly, it is possible to extract a latent pattern or supplement a missing value with high accuracy from data represented as a matrix having scalar values and interval values, such as a set of data of a member user and data of a nonmember user collected through questionnaires.

Meanwhile, the present invention is not limited to the above-described embodiment and various modifications and variations can be made in the present invention without departing from the spirit or scope of the invention.

For example, although the algorithm based on the auxiliary function method is used to estimate the parameter θ that minimizes formula (6) in the above-described embodiment, any other method, for example, steepest descent method, may be used. Further, the parameter θ may be estimated by solving an optimization problem in which nonnegative constraint is not imposed on a factor matrix as represented by formula (7).

In addition, it is possible to construct the operation of each component of the data analysis device described in the aforementioned embodiment as a program, install and execute the program in a computer used as the data analysis device or distribute the program through a network.

### REFERENCE SIGNS LIST

1 Data analysis device
2 External device
10 Interval-valued matrix processing unit
20 Parameter estimation unit
30 Parameter processing unit
40 Recording unit
41 Interval-valued matrix recording unit
42 Parameter recording unit
50 Input/output unit

1. A data analysis device for resolving an interval-valued matrix X that is an I×J matrix having an element xᵢⱼ representing a relationship between a first object i (1≤i≤I, I is an integer equal to or greater than 1) and a second object j (1≤j≤J, J is an integer equal to or greater than 1), the element xᵢⱼ being a scalar value or an interval value, into an I×R factor matrix A having an element aᵢᵣ representing a relationship between the first object i and a factor r (1≤r≤R, R is an integer equal to or greater than 1) and a J×R factor matrix B having an element bⱼᵣ representing a relationship between the second object j and the factor r, the data analysis device comprising:
a parameter estimator configured to estimate the factor matrix A and the factor matrix B such that an objective function is optimized, wherein the objective function includes:
a probability of the element xᵢⱼ taking a scalar value thereof, which is represented using an estimate of the element xᵢⱼ estimated from the factor matrix A and the factor matrix B, for each element xᵢⱼ that is a scalar value, and
a probability of the element xᵢⱼ taking an interval value thereof, which is represented using the estimate of the element xᵢⱼ estimated from the factor matrix A and the factor matrix B, for each element xᵢⱼ that is an interval value.

2. The data analysis device according to claim 1, wherein the probability of the element xᵢⱼ taking an interval value thereof includes a difference between:
a cumulative density function representing a probability of the element xᵢⱼ taking a value equal to or less than an upper limit value of the interval value thereof, and
a cumulative density function representing a probability of the element xᵢⱼ taking a value equal to or less than a lower limit value of the interval value thereof.

3. The data analysis device according to claim 1,
wherein the probability of the element xᵢⱼ taking a scalar value thereof is represented by a probability density function based on a normal distribution.

4. The data analysis device according to claim 1, wherein the parameter estimator repeats update of the factor matrix A and the factor matrix B such that an auxiliary function that is an upper-bound function of the objective function decreases until predetermined repetition end conditions are satisfied.

5. A data analysis method in a data analysis device for resolving an interval-valued matrix X that is an I×J matrix having an element xᵢⱼ representing a relationship between a first object i (1≤i≤I, I is an integer equal to or greater than 1) and a second object j (1≤j≤J, J is an integer equal to or greater than 1), the element xᵢⱼ being a scalar value or an interval value, into an I×R factor matrix A having an element aᵢᵣ representing a relationship between the first object i and a factor r (1≤r≤R, R is an integer equal to or greater than 1) and a J×R factor matrix B having an element bⱼᵣ representing a relationship between the second object j and the factor r, the data analysis method comprising:
estimating, by a parameter estimator, the factor matrix A and the factor matrix B such that an objective function is optimized, wherein the objective function includes:
a probability of the element xᵢⱼ taking a scalar value thereof, which is represented using an estimate of the element xᵢⱼ estimated from the factor matrix A and the factor matrix B, for each element xᵢⱼ that is a scalar value, and
a probability of the element xᵢⱼ taking an interval value thereof, which is represented using the estimate of the element xᵢⱼ estimated from the factor matrix A and the factor matrix B, for each element xᵢⱼ that is an interval value.

6. The data analysis method according to claim 5, wherein the probability of the element xᵢⱼ taking an interval value thereof includes a difference between:
a cumulative density function representing a probability of the element xᵢⱼ taking a value equal to or less than an upper limit value of the interval value thereof and
a cumulative density function representing a probability of the element xᵢⱼ taking a value equal to or less than a lower limit value of the interval value thereof.

7. The data analysis method according to claim 5, wherein the estimating by the parameter estimator includes repeating update of the factor matrix A and the factor matrix B such that an auxiliary function that is an upper-bound function of the objective function decreases until predetermined repetition end conditions are satisfied.

8. A program for causing a computer to serve as each component constituting the data analysis device for resolving an interval-valued matrix X that is an I×J matrix having an element xii representing a relationship between a first object i (1≤i≤I, I is an integer equal to or greater than 1) and a second object j (1≤j≤J, J is an integer equal to or greater than 1), the element xᵢⱼ being a scalar value or an interval value, into an I×R factor matrix A having an element aᵢᵣ representing a relationship between the first object i and a factor r (1≤r≤R, R is an integer equal to or greater than 1) and a J×R factor matrix B having an element bⱼᵣ representing a relationship between the second object j and the factor r, the data analysis device comprising:
a parameter estimator configured to estimate the factor matrix A and the factor matrix B such that an objective function is optimized, wherein the objective function includes:
a probability of the element xᵢⱼ taking a scalar value thereof, which is represented using an estimate of the element xᵢⱼ estimated from the factor matrix A and the factor matrix B, for each element xᵢⱼ that is a scalar value, and
a probability of the element xᵢⱼ taking an interval value thereof, which is represented using the estimate of the element xᵢⱼ estimated from the factor matrix A and the factor matrix B, for each element xᵢⱼ that is an interval value.

9. The data analysis device according to claim 2, wherein the probability of the element xᵢⱼ taking a scalar value thereof is represented by a probability density function based on a normal distribution.

10. The data analysis device according to claim 2, wherein the parameter estimator repeats update of the factor matrix A and the factor matrix B such that an auxiliary function that is an upper-bound function of the objective function decreases until predetermined repetition end conditions are satisfied.

11. The data analysis device according to claim 3, wherein the parameter estimator repeats update of the factor matrix A and the factor matrix B such that an auxiliary function that is an upper-bound function of the objective function decreases until predetermined repetition end conditions are satisfied.

12. The data analysis method according to claim 6, wherein the estimating by the parameter estimator includes repeating update of the factor matrix A and the factor matrix B such that an auxiliary function that is an upper-bound function of the objective function decreases until predetermined repetition end conditions are satisfied.

13. The program according to claim 8, wherein the probability of the element xᵢⱼ taking an interval value thereof includes a difference between;
a cumulative density function representing a probability of the element xᵢⱼ taking a value equal to or less than an upper limit value of the interval value thereof, and
a cumulative density function representing a probability of the element xᵢⱼ taking a value equal to or less than a lower limit value of the interval value thereof.

14. The program according to claim 8, wherein the probability of the element xᵢⱼ taking a scalar value thereof is represented by a probability density function based on a normal distribution.

15. The program according to claim 13, wherein the probability of the element xᵢⱼ taking a scalar value thereof is represented by a probability density function based on a normal distribution.

16. The program according to claim 8, wherein the parameter estimator repeats update of the factor matrix A and the factor matrix B such that an auxiliary function that is an upper-bound function of the objective function decreases until predetermined repetition end conditions are satisfied.

17. The program according to claim 13, wherein the parameter estimator repeats update of the factor matrix A and the factor matrix B such that an auxiliary function that is an upper-bound function of the objective function decreases until predetermined repetition end conditions are satisfied.

18. The program according to claim 14, wherein the parameter estimator repeats update of the factor matrix A and the factor matrix B such that an auxiliary function that is an upper-bound function of the objective function decreases until predetermined repetition end conditions are satisfied.

19. The program according to claim 15, wherein the parameter estimator repeats update of the factor matrix A and the factor matrix B such that an auxiliary function that is an upper-bound function of the objective function decreases until predetermined repetition end conditions are satisfied.

20. The data analysis method according to claim 6, the method further comprising:
generating, based on the estimated factor matrix A and factor matrix B, a latent pattern of data collected through questionnaires, wherein the data includes the element xᵢⱼ.
